(19) United States
(12) Patent Application Publication
(10) Pub. No.: US 2013/0171971 A1
(43) Pub. Date: Jul. 4, 2013

(54) PORTABLE TERMINAL, AUTHENTICATION METHOD, AND COMPUTER PROGRAM PRODUCT

(71) Applicants: Michiko FUJII, Tokyo (JP); Keiya SHIBATA, Tokyo (JP); Takayuki KUNIEDA, Tokyo (JP); Jun MURATA, Tokyo (JP); Koji SUZUKI, Kanagawa (JP)

(72) Inventors: Michiko FUJII, Tokyo (JP); Keiya SHIBATA, Tokyo (JP); Takayuki KUNIEDA, Tokyo (JP); Jun MURATA, Tokyo (JP); Koji SUZUKI, Kanagawa (JP)

(21) Appl. No.: 13/724,078

(22) Filed: Dec. 21, 2012

(30) Foreign Application Priority Data
Dec. 28, 2011 (JP) 2011-289583

(51) Int. Cl. H04W 12/06

(52) U.S. Cl. CPC H04W 12/06
USPC 455/411

(57) ABSTRACT

A portable terminal includes a motion detecting unit that detects a motion of the portable terminal; an authentication information storage unit that stores therein authentication information for use in user authentication; and an authenticating unit that execute user authentication process based on the motion and the authentication information.

### CROSS-REFERENCE TO RELATED APPLICATIONS

The present application claims priority to and incorporates by reference the entire contents of Japanese Patent Application No. 2011-289583 filed in Japan on Dec. 28, 2011.

### BACKGROUND OF THE INVENTION

1. Field of the Invention

The present invention relates to a portable terminal, an authentication method, and a computer program product.

2. Description of the Related Art

Portable terminals such as cellular phones and smartphones store therein important information such as personal information. It is desirable that operations and information viewing be limited so that only an authorized user can use the portable terminal. As means for preventing improper use by limiting a user who can use a portable terminal, personal authentication is used.

As a method of such personal authentication, a method in which specific numbers and passwords are input is widely used. Another method, e.g., a method described in Japanese Patent Application Laid-open No. 2009-020691, is also known, in which a user makes gestures of “Rock,” “Scissors,” “Paper,” etc., and photographs them with a camera of the portable terminal, and when their order is correct, the user is authenticated as an authorized user.

The above-described method, however, involves a problem in that since the motion of a gesture made by a user for authentication is large, the motion is easy to be recognized by a third person. In a portable terminal having a larger touch panel display such as a smartphone, the movement of fingers, etc. on the touch panel display is easy to be visually recognized, posing a similar problem.

Therefore, there is a need for a portable terminal capable of performing authentication with its authentication information hard to be visually recognized by a third person, while using gestures by a user.

### SUMMARY OF THE INVENTION

According to an embodiment, there is provided a portable terminal includes a motion detecting unit that detects a motion of the portable terminal; an authentication information storage unit that stores therein authentication information for use in user authentication; and an authenticating unit that execute user authentication process based on the motion and the authentication information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration example of a portable terminal of a first embodiment of the present invention;

FIG. 2 is a schematic diagram illustrating examples of the pattern of the tilt of the portable terminal of the first embodiment;

FIG. 3 is a schematic diagram illustrating examples of the pattern of the manner of shaking the portable terminal of the first embodiment;

FIG. 4 is a schematic diagram illustrating examples of operation patterns corresponding to the authentication information of the portable terminal of the first embodiment;

FIG. 5 is a flowchart illustrating the flow of processes of an authentication program for the portable terminal of the first embodiment;

FIG. 6 is a schematic diagram illustrating examples of operation patterns corresponding to the authentication information of a portable terminal of a second embodiment;

FIG. 7 is a flowchart illustrating the flow of the processes of an authentication program for the portable terminal of the second embodiment; and

FIG. 8 is a flowchart illustrating the flow of the processes of an authentication program for a portable terminal of a third embodiment.

### DETAILED DESCRIPTION OF THE PREFERRED EMBODIMENTS

Embodiments of a portable terminal will be described in detail hereinafter with reference to the attached drawings.

### First Embodiment

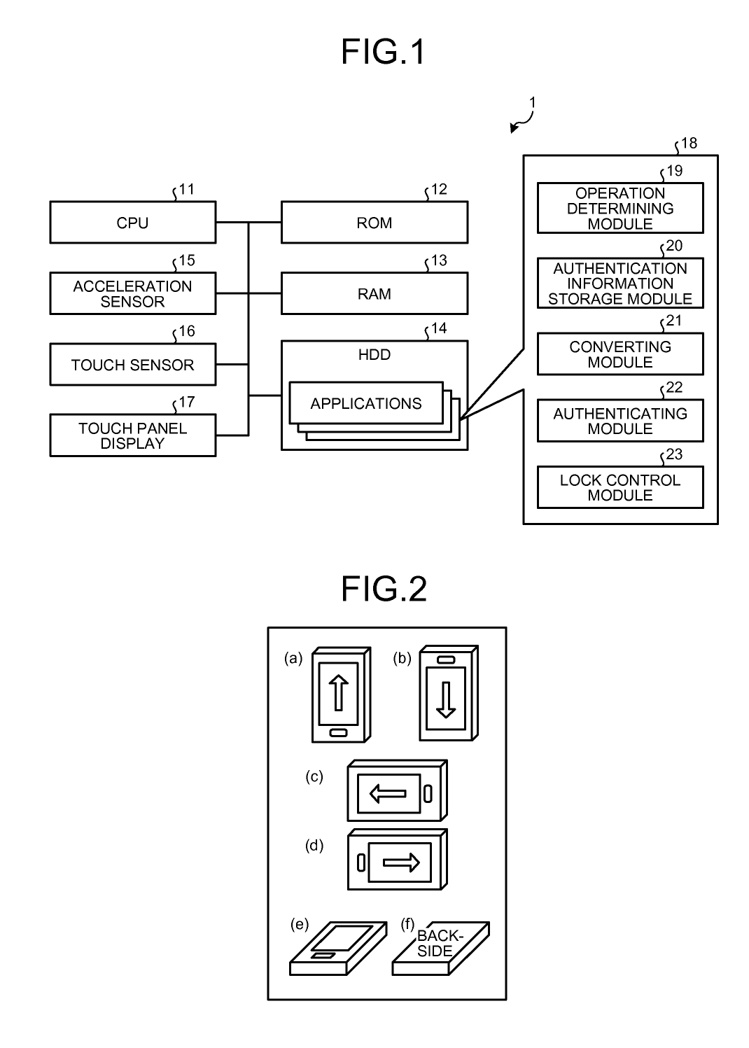

FIG. 1 is a block diagram illustrating the system configuration that performs the authentication of a portable terminal through gestures in accordance with a first embodiment.

A portable terminal 1 includes a CPU 11, a ROM 12, a RAM 13, a storage unit 14, an acceleration sensor 15, a touch sensor 16, a touch panel display 17, and an authentication program 18. The functions of the authentication program 18 may be implemented by hardware apart from software.

The CPU 11 performs the overall control of the portable terminal 1, and has various chipsets and is connected to other devices through the chipsets. The ROM 12 is a read-only memory used as a memory for storing therein programs and data. The RAM 13 is a writable, readable memory used as a memory for expanding programs and data, a memory for printer drawing, etc.

The storage unit 14 is a storage for performing image data accumulation, program accumulation, font-data accumulation, form accumulation, etc. Various kinds of applications are also stored in this storage unit 14. The storage unit 14 may be configured by various storage media that are used in general such as a hard disk drive (HDD), an optical disc, a memory card, and a random access memory (RAM).

The acceleration sensor 15 corresponds to a motion detecting unit that detects the motion of the portable terminal 1. The acceleration sensor 15 acquires parameters at all times at constant time intervals. Specifically, the acceleration sensor 15 acquires an X-value, a Y-value, and a Z-value representing acceleration in the three axes of XYZ.

The acceleration sensor 15 acquires the rates ΔX, ΔY, and ΔZ of change per time of the X-value, Y-value, and Z-value and the values of time interval tX, tY, and tZ when the X-value, Y-value, and Z-value change. The acceleration sensor 15 allows motions such as “swinging” and “tilting” for the portable terminal 1 to be detected.

The touch sensor 16 is an operation detecting unit that detects operations against the touch panel display 17. The touch sensor 16 acquires parameters when a contact against the touch panel display 17 is detected or with timing designated by a related program. The acquired parameters include touch event, the coordinates (Vx, Vy) of a contact position on the touch panel display 17, the number of contact positions, the amount of change of the coordinates of a position (ΔVx, ΔVy), and the amount of change per time (tVx, tVy).

The touch panel display 17 allows data display and operation input from a user and corresponds to an operation displaying unit.

The authentication program 18 provides functions of authenticating the portable terminal 1 based on motion, and is stored in the storage unit 14. The authentication program 18 starts automatically when a state in which a user does not perform any operation is continued for a predetermined time. By the starting, the authentication program 18 puts the portable terminal 1 into a key lock state that prohibits the user from operating the portable terminal 1. To release the key lock state, the user needs to perform motions based on a predetermined motion pattern of the portable terminal 1. The authentication program 18 includes an operation determining module 19, an authentication information storage module 20, a converting module 21, an authenticating module 22, and a lock control module 23.

The operation determining module 19 determines or calculates what motions and operations have been performed from values acquired by the acceleration sensor 15 and the touch sensor 16. Specifically, the operation determining module 19 uses parameters acquired from the acceleration sensor 15 for the determination or calculation of the following items:

1) X-value, Y-value, and X-value in the X-axis, Y-axis, and Z-axis: the orientation of the portable terminal 1;

2) Gravitational accelerations ΔX, ΔY, and ΔZ in the X-axis, Y-axis, and Z-axis: whether a change in the orientation of the portable terminal 1 or a motion of “swinging” or “tilting” has been performed on the portable terminal 1; and

3) Time intervals tX, tY, and tZ: the number of “shaking” the portable terminal 1.

The operation determining module 19 uses the parameters acquired from the touch sensor 16 for the determination of the following items:

4) Touch event: whether there was a motion in which a finger, a stylus, etc. touches the touch panel display 17, whether there was a motion in which a finger, a stylus, etc. leaves the touch panel display 17, whether there is continuous touch with the touch panel display 17, and whether there is continuous separation from the touch panel display 17;

5) The coordinates (Vx, Vy) of a position: a position at which there was touch with the touch panel display 17 and what data and buttons on the touch panel display 17 were selected;

6) The number of positions at which there was touch: the number of fingers that simultaneously touched the touch panel display 17;

7) The amount of change in the coordinates (ΔVx, ΔVy) of a position: distance for which a finger, a stylus, etc. was slid and moved on the touch panel display 17; and

8) The amount of change per time (tVx, tVy): the speed of the movement of a finger, a stylus, etc. on the touch panel display 17.

The operation determining module 19 determines that a motion of “shaking” has been performed successively when the same motion pattern of the portable terminal 1 has been detected successively two times or more. The operation determining module 19 can therefore discriminate between a motion in which the portable terminal 1 is shaken once and a motion in which the portable terminal 1 is successively shaken two times or more.

The operation determining module 19 determines a motion as a motion of “shaking” when the absolute values of the gravitational accelerations ΔX, ΔY, and ΔZ reach or exceed a predetermined threshold. The operation determining module 19 determines as successive motions when the time intervals tX, tY, and tZ between the above-described two motions detected fall within a predetermined time Tmax seconds. There may be a case in which in the middle of the motion of shaking the portable terminal 1 once, gravitational acceleration becomes weak for a moment and exceeds the threshold again thereafter. To prevent such a case from being determined that the portable terminal 1 is being shaken successively, when the time during which the time intervals fell within the threshold was Tmin or less, the motion is not determined as two successive “shaking” motions. In other words, when Tmax≧tX, tY, and tZ≧Tmin, and the absolute values of ΔX, ΔY, and ΔZ reach or exceed the predetermined threshold, the operation determining module 19 determines that there were successive shaking motions.

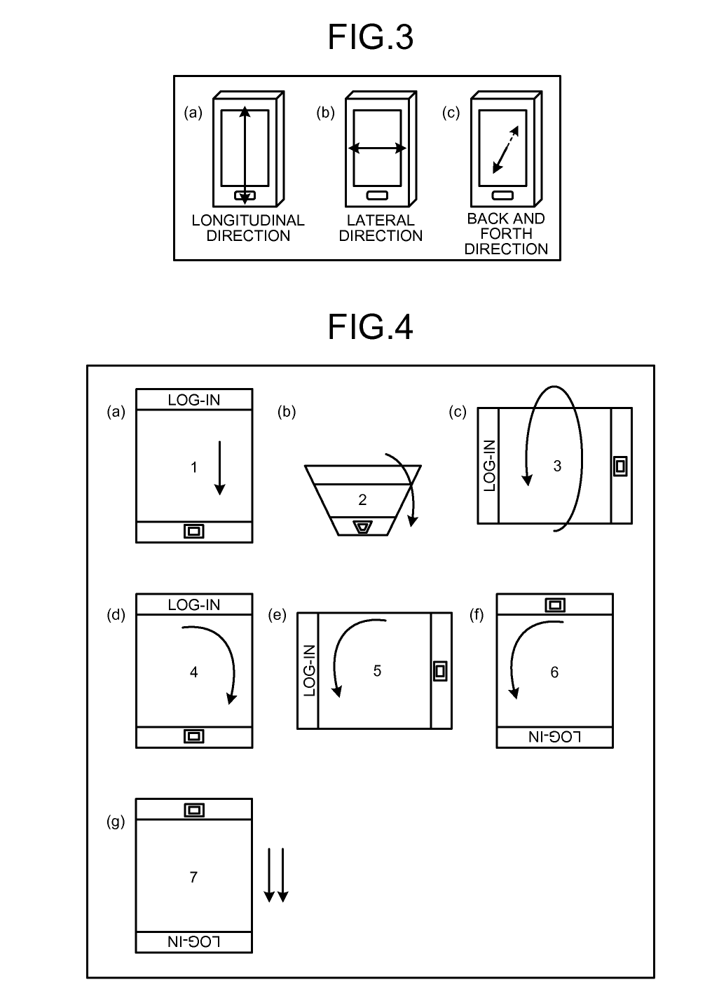

FIGS. 2 and 3 are schematic diagrams illustrating motions for authentication that can be discriminated by the operation determining module 19. FIG. 2 illustrate six patterns (a) to (f) of “tilt” of the portable terminal 1. The operation determining module 19 can separately recognize the six patterns including four orientations in which the touch panel display 17 of the portable terminal 1 lies perpendicular to the ground and two orientations in which the touch panel display 17 lies parallel to the ground. The pattern (a) of FIG. 2 illustrates an orientation in which the touch panel display 17 faces the user, and the upper end of the touch panel display 17 is positioned upward. The pattern (b) of FIG. 2 illustrates an orientation in which the touch panel display 17 faces the user, and the upper end of the touch panel display 17 is positioned downward. The pattern (c) of FIG. 2 illustrates an orientation in which the touch panel display 17 faces the user, and the upper end of the touch panel display 17 is positioned leftward. The pattern (d) of FIG. 2 illustrates an orientation in which the touch panel display 17 faces the user, and the upper end of the touch panel display 17 is positioned rightward. The pattern (e) of FIG. 2 illustrates an orientation in which the touch panel display 17 faces upward. The pattern (f) of FIG. 2 illustrates an orientation in which the touch panel display 17 faces downward.

FIG. 3 illustrate three patterns (a) to (c) of motion of “shaking” the portable terminal 1. The pattern (a) of FIG. 3 illustrates up and down, two patterns of motion of “shaking” the portable terminal 1. The pattern (b) of FIG. 3 illustrates right and left, two patterns of motion of “shaking” the portable terminal 1. The pattern (c) of FIG. 3 illustrates back and forth (the far side and near side of the user), two patterns of motion of “shaking” the portable terminal 1. The operation determining module 19 can therefore determine a total of six patterns of motion of “shaking” the portable terminal 1.

The operation determining module 19 can therefore determine a maximum of 42 patterns of motions by adding the six patterns of “tilt” and 6 by 6=36 patterns, which are a combination of “shaking” motions in each “tilt” state of the portable terminal 1. What motion is used as a pattern for authentication can be appropriately changed in the setting of a program for authentication.

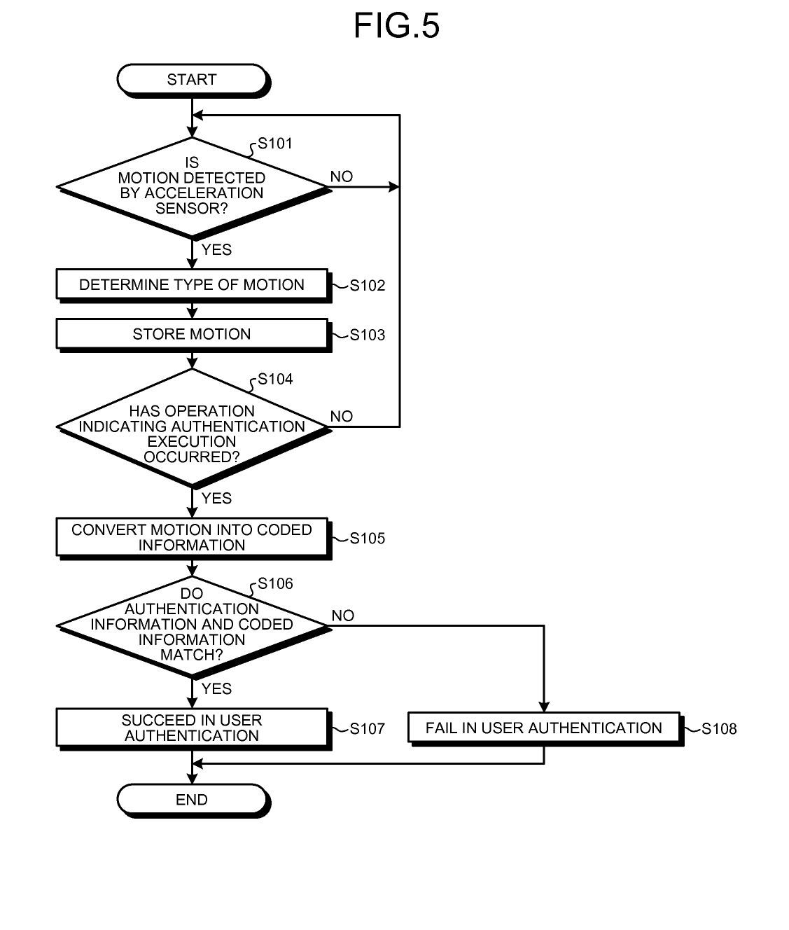

The authentication information storage module 20 stores therein authentication information. The authentication information is information for determining whether a user is an authorized user and includes coded information associated with the motion of the portable terminal 1, which is, for example, a combination of alphabet or a to z, and numbers or 0 to 9. FIG. 4 illustrates an example of a motion pattern associated with the authentication information stored in the authentication information storage module 20.

FIG. 4 illustrate a motion pattern of seven motions (a) to (g). This motion pattern is converted into authentication information and registered. The number displayed on the touch panel display 17 indicates how many times a motion has been detected, counted from one when authentication starts, and added by one each time one motion is detected. The count is not necessarily displayed so as to make the authentication information hard to be recognized by a third person. The motion pattern for authentication may be input to be set optionally by the user and be stored in the authentication information storage module 20.

The motion (a) of FIG. 4 illustrates a motion of “shaking” the portable terminal 1 in the up-and-down direction in the state illustrated in the pattern (a) of FIG. 2. The motion (b) of FIG. 4 illustrates a motion of “tilting” the portable terminal 1 to the state illustrated in the pattern (f) of FIG. 2. The motion (c) of FIG. 4 illustrates a motion of “tilting” the portable terminal 1 to the state illustrated in the pattern (c) of FIG. 2. The motion (d) of FIG. 4 illustrates a motion of “tilting” the portable terminal 1 to the state illustrated in the pattern (a) of FIG. 2. The motion (e) of FIG. 4 illustrates a motion of “tilting” the portable terminal 1 to the state illustrated in the pattern (c) of FIG. 2. The motion (f) of FIG. 4 illustrates a motion of “tilting” the portable terminal 1 to the state illustrated in the pattern (f) of FIG. 2. The motion (g) of FIG. 4 illustrates a motion of “shaking” the portable terminal 1 downward two times successively, which is in the present embodiment set to be a motion that terminates motions for authentication and instructs to execute authentication. The authentication information therefore consists of a pattern of the six motions illustrated in the motion (a) to (f) of FIG. 2.

The converting module 21 converts the motion of the portable terminal 1 into coded information comparable with the authentication information. Information about allocation of coded information corresponding to each motion is stored. Based on the stored allocation, motion conversion is performed.

The authenticating module 22 compares the coded information converted by the converting module 21 with the authentication information stored in the authentication information storage module 20 to determine whether they match. When they match, the authenticating module 22 completes authentication of the user as being recognized as an authorized user. In the present embodiment, when the inputting of all motions is completed and the user performs a motion of “shaking downward two times successively,” which is the above-described motion of the execution of authentication, the authenticating module 22 performs authentication. When succeeding in authentication, the authenticating module 22 instructs operations including releasing a key lock state by the lock control module 23 described later and displaying an authenticated screen for a case when succeeding in authentication.

The lock control module 23 performs the processing of shifting to a key lock state in which operations on the portable terminal 1 are prohibited and the processing of releasing the lock state. The lock control module 23 starts when, for example, no operation on the touch panel display 17 of the portable terminal 1 has occurred for a predetermined time, and shifts the portable terminal 1 to the lock state. The lock control module 23 releases the key lock state when the authenticating module 22 has authenticated a user as an authorized user.

FIG. 5 is a flowchart illustrating the flow of processes of authentication by the motion of the portable terminal 1. This authentication processes occur when, for example, a user tries to operate the touch panel display 17 under the key lock state. The user is notified of “Shake the portable terminal 1 correctly,” for example.

As illustrated in FIG. 5, the operation determining module 19 determines whether a motion of the portable terminal 1 has been detected from the value of the acceleration sensor 15 (Step S101). When a motion of the portable terminal 1 has been detected (Yes at Step S101), the operation determining module 19 determines what motion pattern of the portable terminal 1 the detected motion is (Step S102). When no motion of the portable terminal 1 has been detected (No at Step S101), on the other hand, the processes will be repeated until a motion is detected.

The operation determining module 19 allows the RAM 13, which is a temporary storage area, to store therein the determined motion pattern (Step S103). The operation determining module 19 then determines whether it was an operation indicating authentication execution, or in the present embodiment, a motion of “shaking the portable terminal 1 downward two times successively” (Step S104: receiving unit). When it is determined that an operation indicating authentication execution occurred (Yes at Step S104), the converting module 21 acquires all motion patterns that have been stored in the RAM 13 until then and converts them into coded information comparable with the authentication information (Step S105). The authenticating module 22 compares the coded information with the authentication information stored in the authentication information storage module 20 and determines whether they match (Step S106). When it is determined that the coded information matches the authentication information (Yes at Step S106), the authenticating module 22 authenticates the user as an authorized user to succeed in authentication (Step S107). When it is determined that the coded information does not match the authentication information (No at Step S106), authentication by the authenticating module 22 ends in failure (Step S108). When succeeding in authentication, the process related to authentication terminates, and the lock control module 23 releases the key lock state. When no operation indicating authentication execution has occurred (No at Step S104), the processes of Step S101 and later will be repeated.

According to the portable terminal 1 provided with the above-described authentication program 18 of the present embodiment, authentication can be performed by the motion of “shaking” and “tilting” the portable terminal 1. Therefore, since the motions are complex when viewed by a third person, even if they were visually recognized, the motion pattern for authentication is hard to be followed.

Since a motion instructing the execution of authentication is also allocated to a gesture, there is no need to operate a screen, thereby allowing only one hand to perform motions for authentication and improving convenience related to authentication.

In the execution of authentication, apart from the two successive shaking motions as described above, another motion may be allocated for authentication. In this case, a motion that cannot be mixed up with another motion for authentication may be allocated for the execution of authentication. Other available configurations include arranging an operation button for the execution of authentication on the screen and operating a button on the hardware of the portable terminal 1.

The authentication program 18 is used for the release of the key lock state, and in addition, may be used for authentication when starting another application.

### Second Embodiment

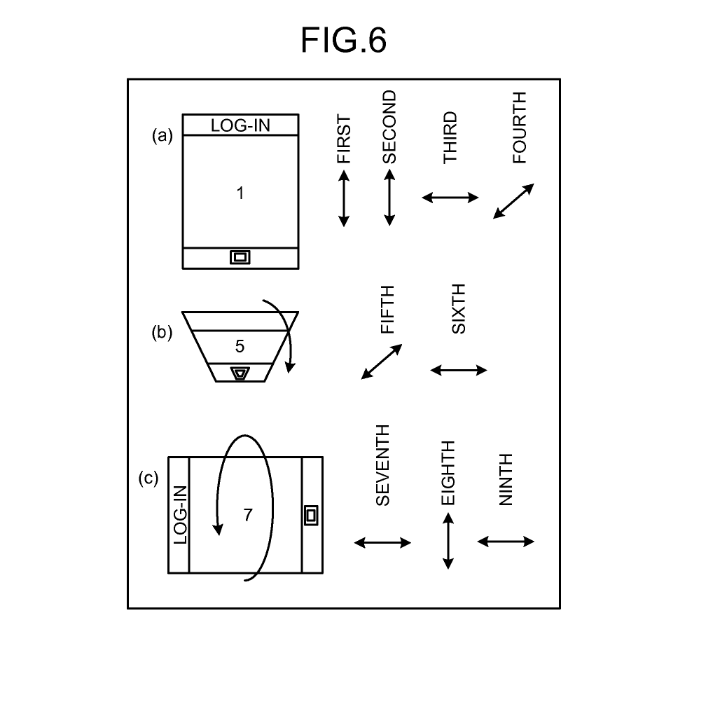

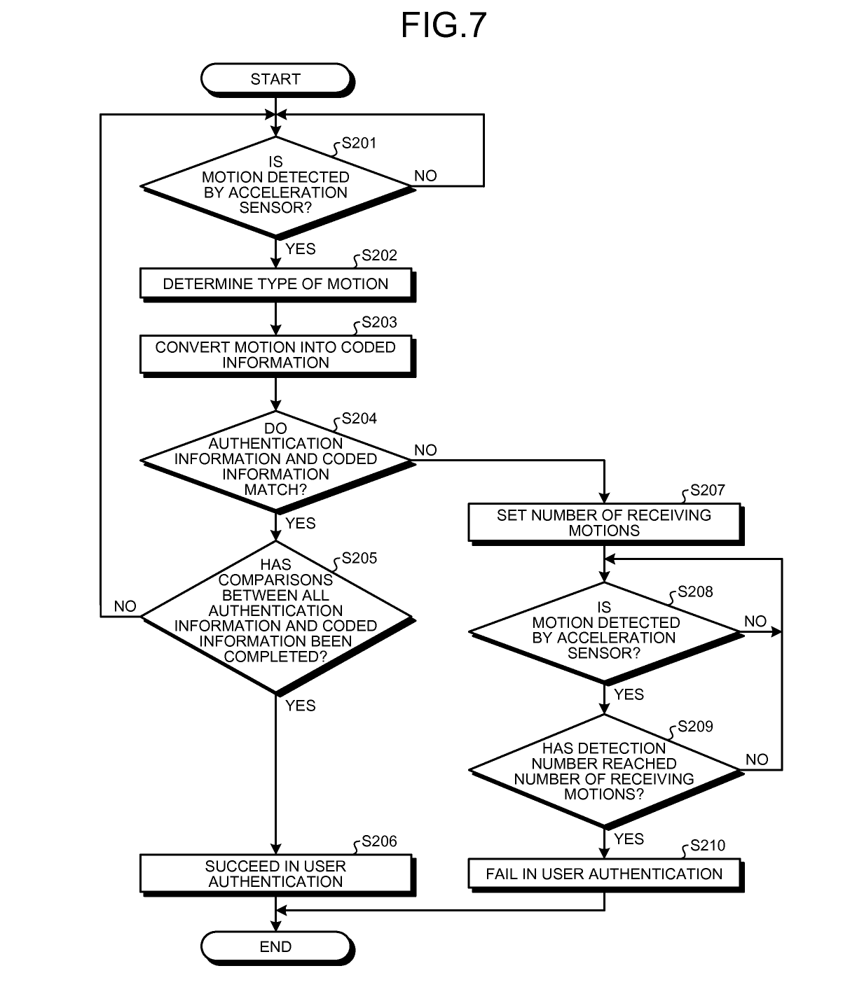

A second embodiment of the present invention will be described. The second embodiment is different from the first embodiment in the motion pattern of the portable terminal 1 for use in authentication. Unlike the first embodiment, in which comparison with the authentication information is performed after the completion of the inputting of all motions, each time a motion is detected once, the motion is coded to be compared with the authentication information. This point will be described using FIGS. 6 and 7. The basic configuration of the portable terminal 1 is similar to the block diagram illustrated in FIG. 1.

FIG. 6 illustrates one example of a motion pattern stored as the authentication information of the portable terminal 1. In this portable terminal 1, a motion in which the “tilt” of the portable terminal 1 is changed is not recognized as one motion, but one piece of the coded information is allocated to a combination of a “tilt” state and a “shaking” motion.

As illustrated in the state (a) of FIG. 6, with the upper end of the touch panel display 17 positioned upward, a user gives, to the portable terminal 1, four motions of “up and down,” “up and down,” “right and left,” and “back and forth” in this order. As illustrated in the state (b) of FIG. 6, then, after the orientation of the portable terminal 1 is changed to a state in which the touch panel display 17 faces downward, the user gives, to the portable terminal 1, two motions of “back and forth” and “right and left” in this order. As illustrated in the state (c) of FIG. 6, then, after the orientation of the portable terminal 1 is changed to a state in which the upper end of the touch panel display 17 is positioned upward, the user gives, to the portable terminal 1, three motions of “right and left,” “up and down,” and “right and left” in this order.

The user gives these nine motions to the portable terminal 1, so that the user who has performed those operations is authenticated.

FIG. 7 is a flowchart illustrating the flow of processes of authentication by the motion of the portable terminal 1. As illustrated in FIG. 7, the operation determining module 19 determines whether a motion of the portable terminal 1 has been detected from the value of the acceleration sensor 15 (Step S201). When a motion of the portable terminal 1 has been detected (Yes at Step S201), the operation determining module 19 determines what motion pattern of the portable terminal 1 the detected motion is (Step S202). When no motion of the portable terminal 1 has been detected (No at Step S201), on the other hand, the processes will be repeated until a motion is detected.

The converting module 21 converts the detected motion pattern into coded information (Step S203). The authenticating module 22 compares the converted coded information with the authentication information and determines whether they match (Step S204). In the present embodiment, the comparison between the coded information and the authentication information is performed each time one motion pattern is detected. Therefore, the Nth (N is an integer not less than one) detected motion pattern is compared with the Nth information from the top out of the authentication information.

When the coded information matches the authentication information (Yes at Step S204), the authenticating module 22 determines whether the comparisons of all the authentication information and the coded information have completed (Step S205). In other words, when the authentication information consists of M (M is an integer satisfying M>=N) pieces of information, motions patterns are detected M times, and when the authentication information matches coded information M times, the determination of this Step S205 is Yes. When it is determined that the comparisons of all the authentication information and the coded information have completed (Yes at Step S205), the authenticating module 22 authenticates the user as an authorized user, succeeding in authentication (Step S206). When it is determined that comparisons between all the authentication information and coded information have not completed (No at Step S205), on the other hand, the process flow returns to Step S201, and authentication of a motion pattern that will be detected next time will be performed again.

When the coded information does not match the authentication information (No at Step S204), the authentication program 18 randomly sets the remaining number of receiving motions, which indicates how many more times a motion of the portable terminal 1 by a user will be received (Step S207: motion number setting unit). The remaining number of receiving motions is, for example, set to a number randomly selected from 1 to 10. The authentication program 18 determines whether the motion of the portable terminal 1 has been detected by the acceleration sensor 15 (Step S208). Whether the detection number has reached the remaining number of receiving motions is determined (Step S209). When no motion of the portable terminal 1 has been detected (No at Step S208), the processes will be repeated until a motion is detected. When the motion of the portable terminal 1 has been detected and this detection number has reached the remaining number of receiving motions (Yes at both Step S208 and Step S209), the authenticating module 22 determines that user authentication has failed and notifies the user of that fact (Step S210). By thus randomly setting the remaining number of receiving motions, the user is not allowed to know the number of the characters of the authentication information, thereby maintaining the strength of authentication. When the motion does not reach the remaining number of receiving motions (No at Step S209), on the other hand, the process of Step S208 and later will be performed repeatedly.

### Third Embodiment

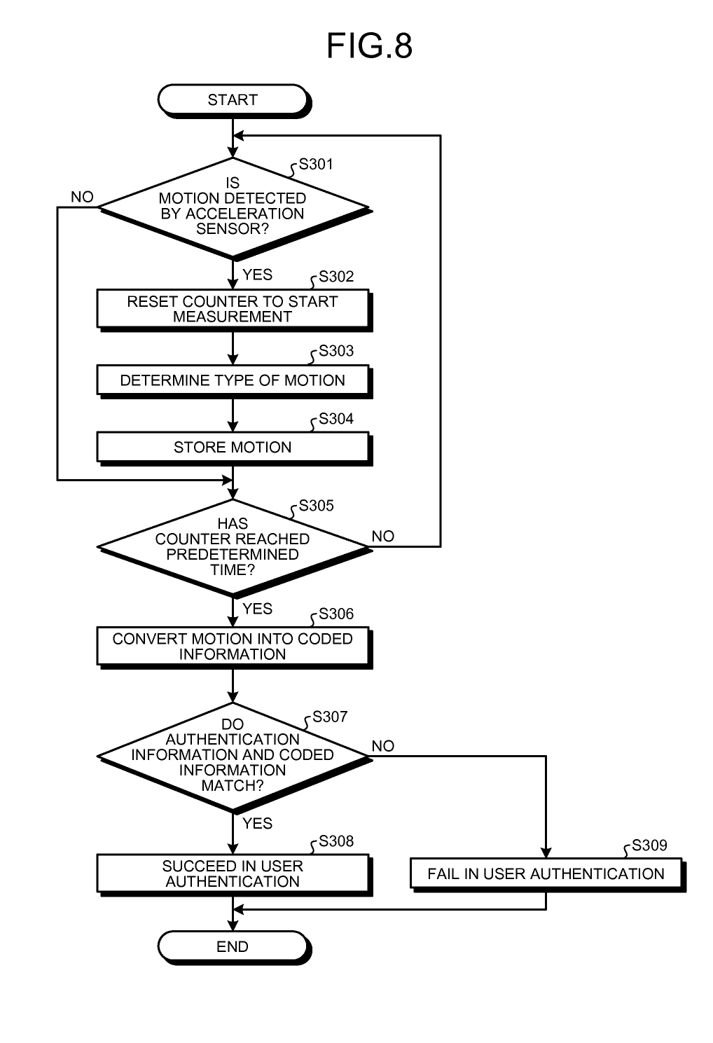

A third embodiment of the present invention will be described. The third embodiment is different in the timing of the execution of authentication. This point will be described using FIG. 8. The basic configuration of the portable terminal 1 is similar to the block diagram illustrated in FIG. 1.

As illustrated in FIG. 8, the operation determining module 19 determines whether a motion of the portable terminal 1 has been detected from the value of the acceleration sensor 15 (Step S301). When a motion of the portable terminal 1 has been detected (Yes at Step S301), the authentication program 18 resets the counter of reception available time to return it to “0”, thereby starting time measurement (Step S302). When no motion of the portable terminal 1 has been detected (No at Step S301), on the other hand, the process flow shifts to Step S305. Under the condition that the counting of the reception available time is not started, the reception available time does not exceed a predetermined time, and then the process flow returns to Step S301 to repeat the processes until a motion is detected.

The operation determining module 19 then determines what motion pattern of the portable terminal 1 the motion is (Step S303). The operation determining module 19 stores the determined motion pattern in the RAM 13, which is a temporary storage area (Step S304).

The operation determining module 19 then determines whether the reception available time under measurement has exceeded the predetermined time (Step S305). The reception available time is a time measured after one motion is detected and until the next motion is detected. When it is determined that the reception available time exceeds the predetermined time, it is determined that the motion of the portable terminal 1 for authentication by the user has completed, and authentication is executed. When a motion is detected before the reception available time exceeds the predetermined time, the reception available time is reset, and measurement is started again from “0.”

With the authentication program 18 of the present embodiment, after giving a motion by gesture to the portable terminal 1 for the authentication of the portable terminal 1, authentication is executed automatically as time passes, thereby reducing operations for authentication and achieving authentication with improved convenience.

When it is determined that the reception available time under measurement has reached the predetermined time (Yes at Step S305), the converting module 21 acquires all the motion patterns stored in the RAM until then and converts them into coded information that is comparable with the authentication information (Step S306). The authenticating module 22 compares the coded information with the authentication information stored in the authentication information storage module 20 and determines whether they match (Step S307). When it is determined that the coded information matches the authentication information (Yes at Step S307), the authenticating module 22 authenticates the user as an authorized user, succeeding in authentication (Step S308). When it is determined that the coded information does not match the authentication information (No at Step S307), authentication by the authenticating module 22 ends in failure (Step S309). When succeeding in authentication, the process related to authentication terminates, and the lock control module 23 releases the key lock state. When it is determined that the reception available time under measurement has not reached the predetermined time (No at Step S305), the processes from Step S301 and later will be repeated.

The authentication program 18 shown in each embodiment can be used not only for the release of the lock function of the portable terminal 1 but also for other uses such as user authentication when starting applications.

The various kinds of processing executed in the authentication program of the foregoing embodiments are provided incorporated in a ROM, etc. in advance.

The various kinds of processing executed in the authentication program of the foregoing embodiments may be provided stored in computer-readable storage media such as a CD-ROM, a flexible disk (FD), a CD-R, and a digital versatile disk (DVD) as a file in a installable format or a file in an executable format.

Furthermore, the various kinds of processing executed in the authentication program of the foregoing embodiments may be provided by storing them on a computer that is connected to a network such as the Internet and downloading them through the network. The various kinds of processing executed in the authentication program of the foregoing embodiments may be provided or distributed through a network such as the Internet.

The present invention provides the effect of performing authentication with its authentication information hard to be visually recognized by a third person, while using gestures by a user.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A portable terminal comprising:
a motion detecting unit that detects a motion of the portable terminal;
an authentication information storage unit that stores therein authentication information for use in user authentication; and
an authenticating unit that execute user authentication process based on the motion and the authentication information.

2. A portable terminal according to claim 1, further comprising:
a converting unit that converts the detected motion into coded information that is associated with the motion and is comparable with the authentication information, wherein
the authenticating unit determines whether the coded information matches the authentication information, and when the coded information matches the authentication information, authenticates a user of the portable terminal as an authorized user.

3. The portable terminal according to claim 1, further comprising:
a lock unit that prohibits operations of the portable terminal; and
a lock releasing unit that releases the prohibition of the operations by the lock unit when the user has been authenticated as the authorized user by the authenticating unit.

4. The portable terminal according to claim 2, wherein
each time the motion detecting unit detects a motion of the portable terminal, the converting unit converts the motion into coded information, and
the authenticating unit determines whether converted Nth (N is an integer not less than one) coded information matches Nth authentication information out of the authentication information, and when pieces of the coded information of all the detected motions match the respectively corresponding pieces of the authentication information, authenticates the user as the authorized user.

5. The portable terminal according to claim 4, further comprising:
a motion number setting unit that, when the authenticating unit determines that the converted coded information does not match the authentication information for the first time, randomly sets a remaining number of receiving motions for use in the determination of the authenticating unit; and
a notifying unit that notifies the user of a failure in authentication when the remaining number of receiving motions matches a number of detecting motions of the portable terminal after the remaining number of receiving motions is set.

6. The portable terminal according to claim 2, further comprising:
a measuring unit that measures time from the detection of one motion to the detection of the next motion by the motion detecting unit; and
an instructing unit that determines whether the measured time has exceeded a predetermined reception available time, instructs the converting unit to convert motion of the portable terminal detected until a point in time when the measured time exceeds the predetermined reception available time, into coded information, and instructs the authenticating unit to execute determination.

7. The portable terminal according to claim 2, further comprising:
a receiving unit that receives a user's operation instructing the execution of authentication; and
an instruction unit that instructs the converting unit to convert motion of the portable terminal detected until a point in time when the receiving unit receives the user's operation, into coded information, and instructs the authenticating unit to execute determination.

8. The portable terminal according to claim 1, wherein the motion of the portable terminal includes at least any one of a motion in the horizontal direction of the portable terminal, a motion in the vertical direction of the portable terminal, a motion of shaking the portable terminal, a motion of tilting the portable terminal to the far side or near side when viewed from the user, and a motion of touching a touch panel of the portable terminal.

9. An authentication method comprising:
detecting a motion of a portable terminal;
storing authentication information for use in user authentication in a storage unit; and
executing user authentication based on the motion and the authentication information.

10. A computer program product comprising a non-transitory computer-readable medium including programmed instructions that cause a computer to execute:
detecting a motion of a portable terminal;
storing authentication information for use in user authentication in a storage unit; and
executing user authentication based on the motion and the authentication information.
